(19) United States
(12) Patent Application Publication
(10) Pub. No.: US 2026/0135480 A1
(43) Pub. Date: May 14, 2026

(54) SWITCHED-CAPACITOR VOLTAGE CONVERTER WITH REVERSE LEAKAGE PREVENTION, CHIP, AND ELECTRONIC DEVICE

(71) Applicant: Zhuhai Nanxin Semiconductor Technology Co., Ltd., Zhuhai (CN)

(72) Inventors: Zhen Lu, Zhuhai (CN); Wei Zhao, Zhuhai (CN)

(73) Assignee: Zhuhai Nanxin Semiconductor Technology Co., Ltd., Zhuhai (CN)

(21) Appl. No.: 19/389,030

(22) Filed: Nov. 14, 2025

(30) Foreign Application Priority Data
Nov. 14, 2024 (CN) 202411627594.9

(51) Int. Cl. H02M 3/07; H02M 1/00; H02M 3/158

(52) U.S. Cl. CPC H02M 3/07; H02M 1/009; H02M 3/158

(57) ABSTRACT

Provided are a switched-capacitor voltage converter with reverse leakage prevention, a chip, and an electronic device. The switched-capacitor voltage converter includes a logic control circuit, a first switching circuit, a second switching circuit, and a switched-capacitor voltage converter circuit. The switched-capacitor voltage converter circuit includes an input voltage terminal, an output voltage terminal, and two leakage paths. Each of the leakage paths includes two leakage branches. Each of the leakage branches includes two switching transistors. By cutting off the leakage paths through the body diodes and the channels of the switching transistors, the chip area is reduced, the cost is lowered, and the charging efficiency is improved.

### CROSS REFERENCE TO THE RELATED APPLICATIONS

This application is based upon and claims priority to Chinese Patent Application No. 202411627594.9, filed on November 14, 2024, the entire contents of which are incorporated herein by reference.

### TECHNICAL FIELD

The present disclosure relates to the technical field of power management chips, and in particular, relates to a switched-capacitor voltage converter with reverse leakage prevention, a chip, and an electronic device.

### BACKGROUND

Switched-capacitor voltage converter are direct current-to-direct current (DC-DC) converters that store energy using capacitors. Compared to inductors, capacitors have a higher energy density. Therefore, switched-capacitor voltage converters that transfer energy using capacitors achieve a significantly higher conversion efficiency than voltage converters that transfer energy using use inductors. Due to the high energy conversion efficiency, switched-capacitor voltage converters are widely used in various charging applications to achieve voltage and current conversion between inputs and outputs at different ratios. Switched-capacitor voltage converters achieve high power density and multi-output functionality with a relatively small overall circuit footprint.

Referring to FIG. 1, FIG. 1 illustrates a single-input multi-output switched-capacitor voltage converter in the related art. As illustrated in FIG. 1, by controlling on or off states of power transistors M1 to M16, connections of capacitors C1A, C1B, C2A, and C2B may be controlled to achieve conversion between the input and the output at different ratios. In FIG. 1, a voltage VIN is applied to an input terminal IN_1, a first output terminal OUT_1 outputs a first voltage VOUT, and a second output terminal VO1_1 outputs a second voltage VMID, such that a single-input multi-output function is implemented. For example, referring to FIG. 1, by turning on the power transistors M1, M4, M7, M9, M11, M12, M14, and M15, and turning off the power transistors M2, M3, M5, M6, M8, M10, M13, and M16, a 4:1 step-down function, i.e., VIN=4*VOUT, may be implemented by series-parallel connections of the capacitors C1A, C1B, C2A, and C2B.

In practical applications of the switched-capacitor voltage converter, in a case where

the voltage VIN drops to a low voltage level, the first voltage VOUT may leak back to VIN via the switched-capacitor voltage converter, causing a waste of electrical energy.

### SUMMARY

The present disclosure provides a switched-capacitor voltage converter with reverse leakage prevention, a chip, and an electronic device, to reduce chip area, reduce costs, and improve charging efficiency.

In a first aspect, some embodiments of the present disclosure provide a switched-capacitor voltage converter with reverse leakage prevention. The switched-capacitor voltage converter includes a logic control circuit, a first switching circuit, a second switching circuit, and a switched-capacitor voltage converter circuit, wherein the switched-capacitor voltage converter circuit includes an input voltage terminal, an output voltage terminal, a first leakage path, and a second leakage path, wherein the first leakage path includes a first leakage branch and a second leakage branch, and the second leakage path includes a third leakage branch and a fourth leakage branch, each of the first leakage branch, the second leakage branch, the third leakage branch, and the fourth leakage branch including two switching transistors.

In a case where the switched-capacitor voltage converter is in a non-operating state, an input voltage applied to the input voltage terminal is lower than an output voltage output by the output voltage terminal, and an absolute value of a difference between the input voltage and the output voltage is greater than a predetermined threshold.

The logic control circuit is configured to control the first switching circuit to cause anodes of body diodes of a first target switching transistor and a second target switching transistor to be both electrically connected to ground; and control the second switching circuit to cause control terminals of the first target switching transistor and the second target switching transistor to be both electrically connected to ground; wherein the first target switching transistor is at least one switching transistor in the first leakage branch, and the second target switching transistor is at least one switching transistor in the third leakage branch or the fourth leakage branch; or the first target switching transistor is at least one switching transistor in the second leakage branch, and the second target switching transistor is at least one switching transistor in the third leakage branch or the fourth leakage branch.

In some embodiments, a common terminal of the first switching circuit is electrically connected to the anode of the body diode of the target switching transistor, a first terminal of the first switching circuit is connected to ground, and a second terminal of the first switching circuit is electrically connected to a source of the target switching transistor; and a common terminal of

the second switching circuit is electrically connected to the control terminal of the target switching transistor, a first terminal of the second switching circuit is connected to ground, and a second terminal of the second switching circuit is electrically connected to a drive voltage terminal.

In some embodiments, in a case where the switched-capacitor voltage converter is in an operating state, the logic control circuit is configured to control the first switching circuit to cause the anodes of the body diodes of the first target switching transistor and the second target switching transistor to be both electrically connected to a source of the target switching transistor; and control the second switching circuit to cause the control terminals of the first target switching transistor and the second target switching transistor to be both electrically connected to the drive voltage terminal, wherein the drive voltage terminal is electrically connected to the logic control circuit.

In some embodiments, the switched-capacitor voltage converter circuit includes a first switching transistor, a second switching transistor, a third switching transistor, a fourth switching transistor, a fifth switching transistor, a sixth switching transistor, a seventh switching transistor, an eighth switching transistor, a ninth switching transistor, a tenth switching transistor, an eleventh switching transistor, a twelfth switching transistor, a thirteenth switching transistor, a fourteenth switching transistor, a fifteenth switching transistor, a sixteenth switching transistor, a first capacitor, a second capacitor, a third capacitor, a fourth capacitor, a fifth capacitor, and a sixth capacitor.

A first terminal of the first switching transistor is electrically connected to a first terminal of the first capacitor and a second terminal of the third switching transistor, and a second terminal of the first switching transistor is electrically connected to a second terminal of the sixteenth switching transistor and the input voltage terminal.

A first terminal of the second switching transistor is connected to ground, and a second terminal of the second switching transistor is electrically connected to a second terminal of the first capacitor and a first terminal of the fourth switching transistor.

A first terminal of the third switching transistor is electrically connected to a second terminal of the fifth switching transistor, a first terminal of the fifth capacitor, a second terminal of the twelfth switching transistor, and a first terminal of the fourteenth switching transistor.

A second terminal of the fourth switching transistor is electrically connected to a first terminal of the twelfth switching transistor, a second terminal of the sixth switching transistor, and a first terminal of the second capacitor.

A first terminal of the fifth switching transistor is electrically connected to a second terminal of the thirteenth switching transistor, a second terminal of the eleventh switching transistor, and a first terminal of the fourth capacitor.

A first terminal of the sixth switching transistor is electrically connected to a second terminal of the seventh switching transistor, a first terminal of the eleventh switching transistor, a second terminal of the tenth switching transistor, and a first terminal of the sixth capacitor.

A first terminal of the seventh switching transistor is electrically connected to a second terminal of the second capacitor and a second terminal of the eighth switching transistor.

A first terminal of the eighth switching transistor is connected to ground.

A first terminal of the ninth switching transistor is connected to ground, and a second terminal of the ninth switching transistor is electrically connected to a first terminal of the tenth switching transistor and a second terminal of the fourth capacitor.

A first terminal of the thirteenth switching transistor is electrically connected to a second terminal of the third capacitor and a second terminal of the fifteenth switching transistor.

A second terminal of the fourteenth switching transistor is electrically connected to a first terminal of the third capacitor and a first terminal of the sixteenth switching transistor.

A first terminal of the fifteenth switching transistor is connected to ground, a second terminal of the fifth capacitor is connected to ground, and a second terminal of the sixth capacitor is connected to ground.

Control terminals of the first switching transistor, the second switching transistor, the third switching transistor, the fourth switching transistor, the fifth switching transistor, the sixth switching transistor, the seventh switching transistor, the eighth switching transistor, the ninth switching transistor, the tenth switching transistor, the eleventh switching transistor, the twelfth switching transistor, the thirteenth switching transistor, the fourteenth switching transistor, the fifteenth switching transistor, and the sixteenth switching transistor are all electrically connected to the logic control circuit.

In some embodiments, the first leakage path includes the first switching transistor, the third switching transistor, the fifth switching transistor, and the eleventh switching transistor; and the second leakage path includes the sixth switching transistor, the twelfth switching transistor, the fourteenth switching transistor, and the sixteenth switching transistor.

In some embodiments, the first leakage branch includes the first switching transistor and the third switching transistor, the second leakage branch includes the fifth switching transistor and the eleventh switching transistor, the third leakage branch includes the fourteenth switching transistor and the sixteenth switching transistor, and the fourth leakage branch includes the sixth switching transistor and the twelfth switching transistor.

In some embodiments, the predetermined threshold is a minimum value of four times a forward conduction threshold of the body diode and a sum of conduction thresholds of the four switching transistors in the first leakage path or the second leakage path.

In some embodiments, the first switching transistor, the second switching transistor, the third switching transistor, the fourth switching transistor, the fifth switching transistor, the sixth switching transistor, the seventh switching transistor, the eighth switching transistor, the ninth switching transistor, the tenth switching transistor, the eleventh switching transistor, the twelfth switching transistor, the thirteenth switching transistor, the fourteenth switching transistor, the fifteenth switching transistor, and the sixteenth switching transistor are all N-type switching transistors.

In a second aspect, some embodiments of the present disclosure provide a chip. The chip includes the switched-capacitor voltage converter as according to the first aspect.

In a third aspect, some embodiments of the present disclosure provide an electronic device. The electronic device includes the chip according to the second aspect.

The embodiments of the present disclosure achieve the following beneficial effects.

In a case where the switched-capacitor voltage converter is in a non-operating state, an input voltage applied to the input voltage terminal is lower than an output voltage output by the output voltage terminal, and an absolute value of a difference between the input voltage and the output voltage is greater than a predetermined threshold, the logic control circuit controls the first switching circuit to cause anodes of body diodes of the first target switching transistor and the second target switching transistor to be both electrically connected to ground, thereby cutting off the leakage path through the body diodes of the switching transistors; and controls the second switching circuit to cause control terminals of the first target switching transistor and the second target switching transistor to be both electrically connected to ground, thereby cutting off the reverse leakage path through channels of the switching transistors. By cutting off the leakage paths through the body diodes and the channels of the switching transistors, all leakage paths from the output voltage terminal OUT to the input voltage terminal IN are cut off, such that reverse leakage of the switched-capacitor voltage converter is prevented. In the present disclosure, since no additional power transistors need to be introduced, the chip area is reduced, the cost is lowered, and the charging efficiency is improved.

For details about the beneficial effects achieved by the method according to the second aspect and the embodiments of the second aspect, reference may be made to the beneficial effects achieved by the first aspect or any embodiment of the first aspect, which are not described herein any further.

### BRIEF DESCRIPTION OF THE DRAWINGS

For clearer descriptions of the technical solutions according to the embodiments of the present disclosure or in the prior art, drawings that are to be referred for description of the embodiments or the prior art are briefly described hereinafter. Apparently, the drawings described hereinafter merely illustrate some embodiments of the present disclosure. Persons of ordinary skill in the art may also derive other embodiments based on the drawings described herein.

FIG. 1 is a schematic structural diagram of a single-input multi-output switched-capacitor voltage converter provided in the related art.

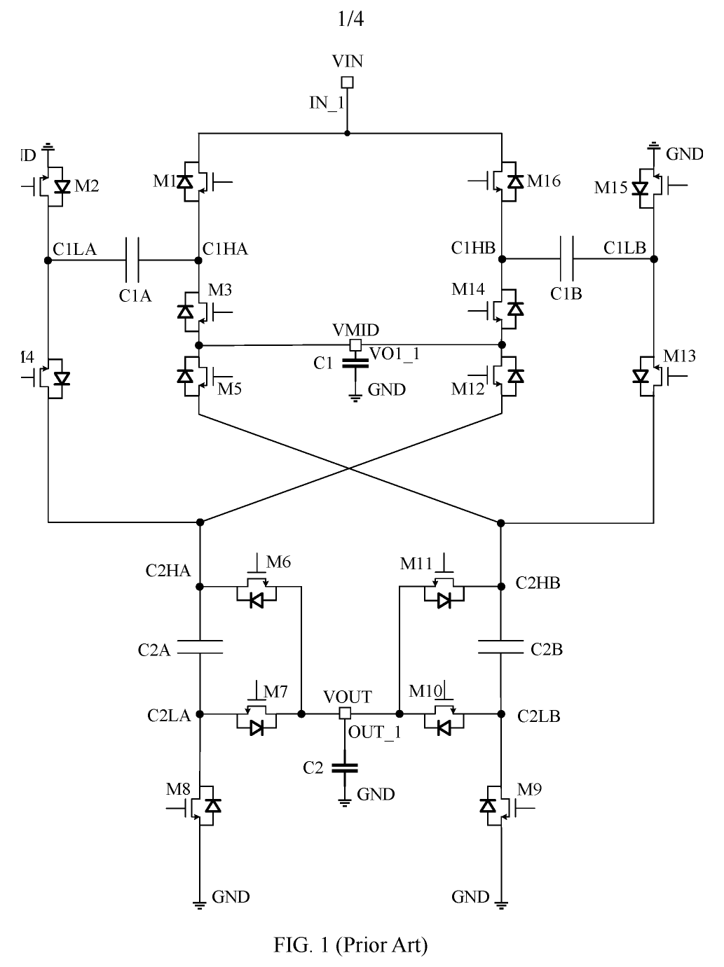

FIG. 2 is a circuit diagram of an anti-leakage circuit provided in the related art.

FIG. 3 is a schematic structural diagram of a switched-capacitor voltage converter with reverse leakage prevention according to some embodiments of the present disclosure.

FIG. 4 is a circuit diagram of a switched-capacitor voltage converter with reverse leakage prevention according to some embodiments of the present disclosure.

### DETAILED DESCRIPTION OF THE EMBODIMENTS

In the present disclosure, the term "at least one" refers to one or more than one, and the term "a plurality of" refers to two or more than two. The term "and/or" is merely an association relationship for describing associated objects, which represents that there may exist three types of relationships. For example, the phrase "A and/or B" means (A), (B), or (A and B), wherein A and B may be single or plural. In addition, the symbol "/" generally represents an "or" relationship between associated objects before and after the symbol. The expression "at least one of the following" or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms "first," "second," and the like are merely for the illustration purpose, and shall not be construed as indicating or implying a relative importance.

In the description of the present disclosure, it should be understood that the terms "central," "transversal," "longitudinal," "upper," "lower," "left," "right," "front," "rear," and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms "connected," "coupled," and derivatives forms thereof shall be understood in a broad sense. For example, the terms "connected," "coupled," and derivatives form thereof for depicting the circuit structure, in addition to physical connection, may also be understood as electrical connections or signal connection. The connection, for example, may be direct connection, i.e., the physical connection or, indirect connection via at least one middle element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

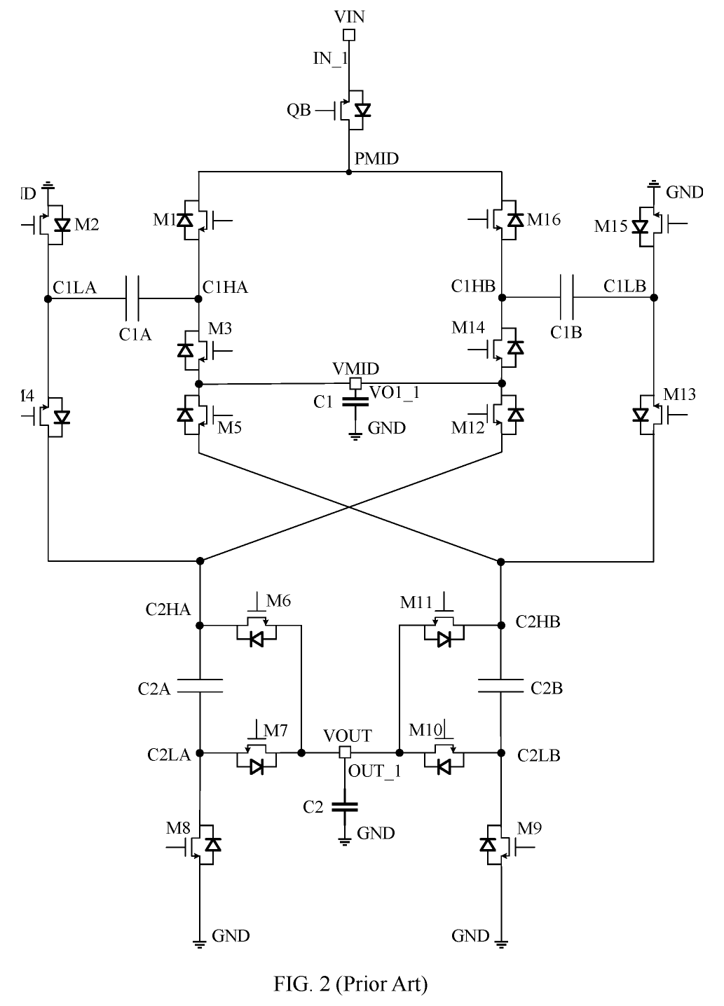

In the related art, to prevent the output terminal of the switched-capacitor voltage converter from leaking current back to the input terminal of the switched-capacitor voltage converter, which would cause a waste of electrical energy, an anti-leakage circuit is provided. Referring to FIG. 2, this solution involves inserting a power transistor QB between an input terminal IN_1 and the switched-capacitor voltage converter. A body diode of the power transistor QB is oriented from VIN towards an input node PMID of the switched-capacitor voltage converter. In a case where the power transistor QB is turned off, a reverse leakage path from an output terminal OUT_1 to the input terminal IN_1 in the switched-capacitor voltage converter may be directly cut off.

Referring to FIG. 2, the technical solution of additionally inserting the power transistor QB prevents leakage from the output terminal OUT_1 to the input terminal IN_1. However, the additionally inserted power transistor QB requires extra area overhead, thereby increasing the chip area and raising the cost. Additionally, during normal operation of the switched-capacitor voltage converter, a charging current flowing from the input terminal IN_1 passes through the power transistor QB, which generates additional power loss. This leads to a decrease in charging efficiency and an increase in heat generation by the chip.

To solve the problems in the related art caused by introducing an extra power transistor, such as large chip area, high cost, and low charging efficiency, some embodiments of the present disclosure provide a switched-capacitor voltage converter with reverse leakage prevention, such that reverse leakage of the switched-capacitor voltage converter is prevented without introducing an additional power transistor.

To reduce chip area, lower costs, and improve charging efficiency, some embodiments of the present disclosure provide a switched-capacitor voltage converter with reverse leakage prevention, a chip, and an electronic device.

The switched-capacitor voltage converter with reverse leakage prevention may be a chip or a circuit module.

The chip may include the switched-capacitor voltage converter with reverse leakage prevention.

In the present disclosure, the electronic device may include, but is not limited to: an adapter, a charger, a tablet computer, a smart home device, a vehicle, and a wearable device.

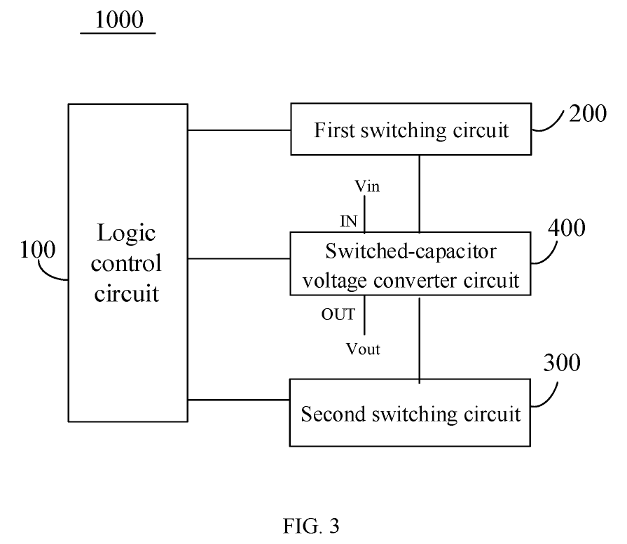

Referring to FIG. 3, FIG. 3 is a schematic structural diagram of a switched-capacitor voltage converter 1000 with reverse leakage prevention according to some embodiments of the present disclosure. As illustrated in FIG. 3, the switched-capacitor voltage converter 1000 with reverse leakage prevention includes a logic control circuit 100, a first switching circuit 200, a second switching circuit 300, and a switched-capacitor voltage converter circuit 400.

The logic control circuit 100 is electrically connected to the first switching circuit 200, the second switching circuit 300, and the switched-capacitor voltage converter circuit 400. The switched-capacitor voltage converter circuit 400 is electrically connected to the first switching circuit 200 and the second switching circuit 300. The switched-capacitor voltage converter circuit 400 has an input voltage terminal IN configured to receive an input voltage Vin and an output voltage terminal OUT configured to output an output voltage Vout.

The reverse leakage occurs in the switched-capacitor voltage converter due to two causes. A first cause is that, body diodes of switching transistors in a path from the output voltage terminal OUT to the input voltage terminal IN cause leakage from the output voltage Vout to the input voltage Vin. A second cause is that, one or more gate voltages of one or more switching transistors in the path from the output voltage terminal OUT to the input voltage terminal IN are biased to a source of the one or more switching transistors respectively. Therefore, in a case where the input voltage Vin is excessively low, a voltage difference between a gate and a drain of the each of the these switching transistors may be caused to be greater than a switching threshold voltage, leading to leakage from the output voltage Vout to the input voltage Vin via a channel of the switching transistor. That is, the reverse leakage in the switched-capacitor voltage converter mainly occurs via the body diodes of the switching transistors in the path from the output voltage terminal OUT to the input voltage terminal IN, and via the channels of the switching transistors in a case where the voltage difference between the gate and the drain of each of these switching transistors is greater than the switching threshold voltage.

Therefore, a circuit from the output voltage terminal OUT to the input voltage terminal IN in the switched-capacitor voltage converter circuit 400 is defined as a leakage circuit. For example, in a case where the switched-capacitor voltage converter circuit 400 includes two circuit paths, these two circuit paths are defined as a first leakage path and a second leakage path respectively, that is, the first leakage path and the second leakage path form a leakage path. Moreover, the switched-capacitor voltage converter circuit 400 has two output terminals, that is, a middle voltage terminal VO1 and the output voltage terminal OUT. The middle voltage terminal VO1 outputs a middle output voltage Vmid. Using the middle voltage terminal VO1 as a middle node, each leakage path of the first leakage path and the second leakage path is divided into two branches: a leakage branch from the middle voltage terminal VO1 to the input voltage terminal IN, and a leakage branch from the output voltage terminal OUT to the middle voltage terminal VO1. For example, the first leakage path is divided into two branches: a first leakage branch from the middle voltage terminal VO1 to the input voltage terminal IN and a second leakage branch from the output voltage terminal OUT to the middle voltage terminal VO1. Similarly, the second leakage path is divided into two branches: a third leakage branch from the middle voltage terminal VO1 to the input voltage terminal IN and a fourth leakage branch from the output voltage terminal OUT to the middle voltage terminal VO1.

Each leakage branch includes at least one switching transistor. For example, each of the first leakage branch, the second leakage branch, the third leakage branch, and the fourth leakage branch includes two switching transistors. That is, each of the first leakage path and the second leakage path includes four switching transistors. Therefore, reverse leakage from the output voltage terminal OUT to the input voltage terminal IN may potentially occur only in a case where the output voltage Vout from the output voltage terminal OUT needs to travel through the four switching transistors of the first leakage path and/or the four switching transistors of the second leakage path.

To effectively prevent reverse leakage of the switched-capacitor voltage converter, it is necessary to cut off all the leakage paths from the output voltage terminal OUT to the input voltage terminal IN. This means that both the first leakage path and the second leakage path need to be cut off. Therefore, it is necessary to select at least one switching transistor in the first leakage path (referred to as a first target switching transistor) and at least one switching transistor in the second leakage path (referred to as a second target switching transistor) to completely cut off both the first and second leakage paths and prevent the occurrence of reverse leakage. Since the first leakage path includes the first leakage branch and the second leakage branch, the second leakage path includes the third leakage branch and the fourth leakage branch, and each of these four branches includes two switching transistors, it is necessary to select at least one switching transistor in the first leakage branch or the second leakage branch (referred to as the first target switching transistor) and at least one switching transistor in the third leakage branch or the fourth leakage branch (referred to as the second target switching transistor) to completely cut off both the first and second leakage paths and prevent reverse leakage.

Based on the analysis of the causes of reverse leakage, in some embodiments, in a case where the switched-capacitor voltage converter is in a non-operating state, to prevent reverse leakage, the logic control circuit is configured to control the first switching circuit to cause the anodes of the body diodes of the first target switching transistor and the second target switching transistor to be both electrically connected to ground via the first switching circuit, thereby cutting off the leakage path via the body diodes of the first and second target switching transistors. Furthermore, the logic control circuit is also configured to control the second switching circuit to cause the control terminals of the first target switching transistor and the second target switching transistor to be both electrically connected to ground via the second switching circuit. In this case, the voltage difference between the gate and source of the first and second target switching transistors is less than the switching threshold voltage, thereby cutting off the reverse leakage path through the channels of the first and second target switching transistors. The first target switching transistor may be at least one switching transistor in the first leakage path, and the second target switching transistor may be at least one switching transistor in the second leakage path. Since the first leakage path includes the first leakage branch and the second leakage branch, the second leakage path includes the third leakage branch and the fourth leakage branch, and each of the four branches includes two switching transistors, the first target switching transistor may be at least one switching transistor in the first leakage branch, and the second target switching transistor may be at least one switching transistor in the third leakage branch or the fourth leakage branch; or the first target switching transistor may be at least one switching transistor in the second leakage branch, and the second target switching transistor may be at least one switching transistor in the third leakage branch or the fourth leakage branch.

For example, in a case where the input voltage Vin of the switched-capacitor voltage converter circuit 400 drops to a low voltage, causing the input voltage Vin to be lower than the output voltage Vout, and the absolute value of the difference between the input voltage Vin and the output voltage Vout is greater than a predetermined threshold, the problem of reverse leakage from the output voltage Vout to the input voltage Vin may be present. Therefore, in a case where the switched-capacitor voltage converter is in a non-operating state, the input voltage Vin applied to the input voltage terminal IN is lower than the output voltage Vout output by the output voltage terminal OUT, and the absolute value of the difference between the input voltage Vin and the output voltage Vout is greater than a predetermined threshold, the logic control circuit 100 is configured to control the first switching circuit 200 to cause the anodes of the body diodes of the first target switching transistor and the second target switching transistor to be both electrically connected to ground via the first switching circuit 200; and control the second switching circuit 300 to cause the control terminals of the first target switching transistor and the second target switching transistor to be both electrically connected to ground via the second switching circuit 300. Herein, the first target switching transistor is at least one switching transistor in the first leakage branch, and the second target switching transistor is at least one switching transistor in the third leakage branch or the fourth leakage branch; or the first target switching transistor is at least one switching transistor in the second leakage branch, and the second target switching transistor is at least one switching transistor in the third leakage branch or the fourth leakage branch.

The relationship between the predetermined threshold, the forward conduction threshold of the body diode, and the switching threshold voltage of the switching transistor is described in detail hereinafter.

In some embodiments, in a case where the switched-capacitor voltage converter is in a non-operating state, the input voltage applied to the input voltage terminal is lower than the output voltage output by the output voltage terminal, and the absolute value of the difference between the input voltage and the output voltage is greater than a predetermined threshold, the logic control circuit controls the first switching circuit to cause the anodes of the body diodes of the first and second target switching transistors to be both electrically connected to ground; and controls the second switching circuit to cause the control terminals of the first and second target switching transistors to be both electrically connected to ground. By cutting off the leakage paths through both the body diodes and the channels of the first and second target switching transistors, all leakage paths from the output voltage terminal OUT to the input voltage terminal IN are cut off, such that reverse leakage of the switched-capacitor voltage converter is prevented. In the present disclosure, since no additional power transistors need to be introduced, the chip area is reduced, the cost is lowered, and the charging efficiency is improved.

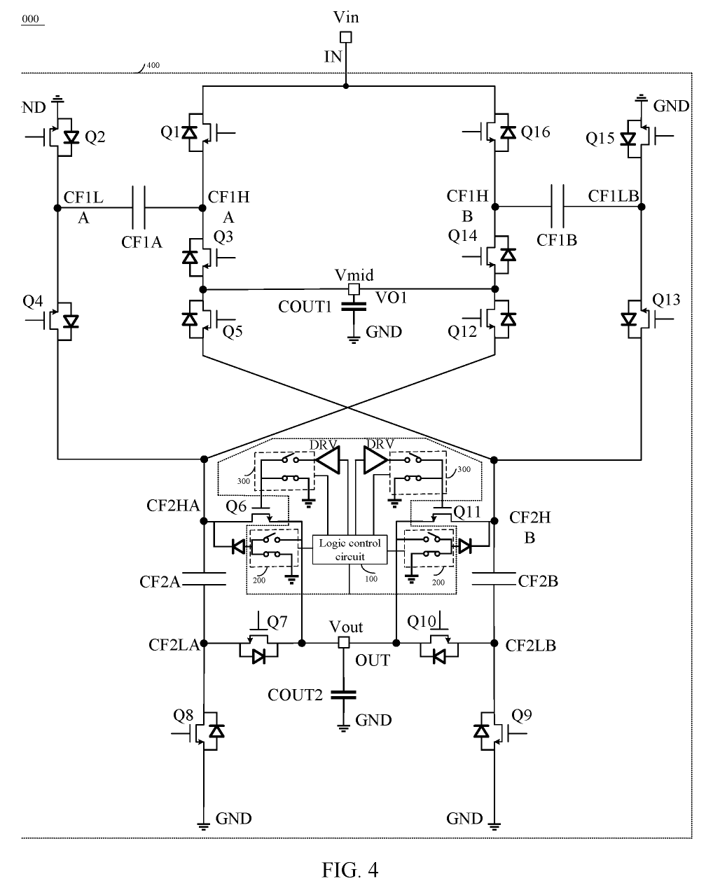

In some embodiments, referring to FIG. 4, which illustrates a switched-capacitor voltage converter with reverse leakage prevention according to some embodiments of the present disclosure, any selected switching transistor is referred to as a target switching transistor (e.g., Q6 or Q11).

A common terminal of the first switching circuit 200 is electrically connected to the anode of the body diode of the target switching transistor (e.g., Q6 or Q11), a first terminal of the first switching circuit 200 is connected to ground, and a second terminal of the first switching circuit 200 is electrically connected to a source of the target switching transistor (Q6 or Q11).

A common terminal of the second switching circuit 300 is electrically connected to a control terminal of the target switching transistor (Q6 or Q11), a first terminal of the second switching circuit 300 is connected to ground, and a second terminal of the second switching circuit 300 is electrically connected to a drive voltage terminal DRV.

The drive voltage terminal DRV is configured to supply a voltage to the control terminal of the target switching transistor. In practical applications, the voltage range of the drive voltage terminal DRV is typically set to be from Vout to Vout+5V. The logic control circuit controls the voltage of the drive voltage terminal DRV to switch between Vout and Vout+5V to control the on or off state of the target switching transistor. A person skilled in the art may understand that the target switching transistor may be turned on in a case where the voltage of the drive voltage terminal DRV is greater than Vout+Vth, wherein Vth denotes the switching threshold voltage between the gate and source of the target switching transistor. Typically, Vth is less than 5 V. For example, in a case where the voltage of the drive voltage terminal DRV is Vout, the target switching transistor is turned off because the source voltage of the target switching transistor is Vout. In a case where the voltage of the drive voltage terminal DRV is Vout+Vth, the target switching transistor is turned on because the source voltage of the target switching transistor is Vout.

In some embodiments, referring to FIG. 4, in a case where the switched-capacitor voltage converter is in an operating state, the logic control circuit 100 is configured to control the first switching circuit 200 to cause the anodes of the body diodes of the first and second target switching transistors to be both electrically connected to the first terminal of the target switching transistor; and control the second switching circuit 300 to cause the control terminals of the first and second target switching transistors to be both electrically connected to the drive voltage terminal DRV, wherein the drive voltage terminal DRV is electrically connected to the logic control circuit 100.

The reverse leakage prevention operation of the switched-capacitor voltage converter in the present disclosure is performed in a case where the switched-capacitor voltage converter is in a non-operating state, the input voltage applied to the input voltage terminal is lower than the output voltage from the output voltage terminal, and the absolute value of the difference between the input and output voltages is greater than a predetermined threshold. Therefore, in a case where the switched-capacitor voltage converter is in an operating state, the anodes of the body diodes of the first and second target switching transistors do not need to be connected to ground, and the control terminals of the first and second target switching transistors also do not need to be connected to ground.

In some embodiments, referring to FIG. 4, the switched-capacitor voltage converter circuit 400 includes a first switching transistor Q1, a second switching transistor Q2, a third switching transistor Q3, a fourth switching transistor Q4, a fifth switching transistor Q5, a sixth switching transistor Q6, a seventh switching transistor Q7, an eighth switching transistor Q8, a ninth switching transistor Q9, a tenth switching transistor Q10, an eleventh switching transistor Q11, a twelfth switching transistor Q12, a thirteenth switching transistor Q13, a fourteenth switching transistor Q14, a fifteenth switching transistor Q15, a sixteenth switching transistor Q16, a first capacitor CF1A, a second capacitor CF2A, a third capacitor CF1B, a fourth capacitor CF2B, a fifth capacitor COUT1, and a sixth capacitor COUT2.

A first terminal of the first switching transistor Q1 is electrically connected to a first terminal of the first capacitor CF1A and a second terminal of the third switching transistor Q3 at a first connection node CF1HA. A second terminal of the first switching transistor Q1 is electrically connected to the input voltage terminal IN of the switched-capacitor voltage converter circuit 400.

A first terminal of the second switching transistor Q2 is connected to ground, and a second terminal of the second switching transistor Q2 is electrically connected to a second terminal of the first capacitor CF1A and a first terminal of the fourth switching transistor Q4 at a second connection node CF1FA.

A first terminal of the third switching transistor Q3 is electrically connected to a second terminal of the fifth switching transistor Q5 and the middle voltage terminal VO1 of the switched-capacitor voltage converter circuit 400. The middle voltage terminal VO1 is connected to ground via the fifth capacitor COUT1, i.e., the middle voltage terminal VO1 is electrically connected to a first terminal of the fifth capacitor COUT1, and a second terminal of the fifth capacitor COUT1 is connected to ground GND. Herein, the middle voltage terminal VO1 serves as one output terminal of the switched-capacitor voltage converter circuit 400 for outputting a first output voltage Vmid.

A second terminal of the fourth switching transistor Q4 is electrically connected to a first terminal of the twelfth switching transistor Q12, a second terminal of the sixth switching transistor Q6, and a first terminal of the second capacitor CF2A at a third connection node CF2HA.

A first terminal of the fifth switching transistor Q5 is electrically connected to a second of the thirteenth switching transistor Q13, a second terminal of the eleventh switching transistor Q11, and a first terminal of the fourth capacitor CF2B at a seventh connection node CF2HB.

A first terminal of the sixth switching transistor Q6 is electrically connected to a second terminal of the seventh switching transistor Q7 and the output voltage terminal OUT of the switched-capacitor voltage converter circuit 400. The output voltage terminal OUT is connected to ground through the sixth capacitor COUT2, i.e., the output voltage terminal OUT is electrically connected to a first terminal of the sixth capacitor COUT2, and a second terminal of the sixth capacitor COUT2 is connected to ground. Herein, the output voltage terminal OUT serves as another output terminal of the switched-capacitor voltage converter circuit 400 for outputting an output voltage Vout.

A first terminal of the seventh switching transistor Q7 is electrically connected to a second terminal of the second capacitor CF2A and a second terminal of the eighth switching transistor Q8 at a fourth connection node CF2LA.

A first terminal of the eighth switching transistor Q8 is connected to ground.

A first terminal of the sixteenth switching transistor Q16 is electrically connected to a second terminal of the fourteenth switching transistor Q14 and a first terminal of the third capacitor CF1B at a fifth connection node CF1HB. A second terminal of the sixteenth switching transistor Q16 is electrically connected to the input voltage terminal IN of the switched-capacitor voltage converter circuit 400.

A first terminal of the fifteenth switching transistor Q15 is connected to ground, and a second terminal of the fifteenth switching transistor Q15 is electrically connected to a first terminal of the thirteenth switching transistor Q13 and a second terminal of the third capacitor CF1B at a sixth connection node CF1LB.

A first terminal of the fourteenth switching transistor Q14 is electrically connected to a second terminal of the twelfth switching transistor Q12 and the middle voltage terminal VO1 of the switched-capacitor voltage converter circuit 400.

A first terminal of the eleventh switching transistor Q11 is electrically connected to a second terminal of the tenth switching transistor Q10 and the output voltage terminal OUT of the switched-capacitor voltage converter circuit 400.

A first terminal of the tenth switching transistor Q10 is electrically connected to a second terminal of the ninth switching transistor Q9 and a second terminal of the fourth capacitor CF2B at an eighth connection node CF2LB.

A first terminal of the ninth switching transistor Q9 is connected to ground.

Control terminals of the first switching transistor Q1, the second switching transistor Q2, the third switching transistor Q3, the fourth switching transistor Q4, the fifth switching transistor Q5, the sixth switching transistor Q6, the seventh switching transistor Q7, the eighth switching transistor Q8, the ninth switching transistor Q9, the tenth switching transistor Q10, the eleventh switching transistor Q11, the twelfth switching transistor Q12, the thirteenth switching transistor Q13, the fourteenth switching transistor Q14, the fifteenth switching transistor Q15, and the sixteenth switching transistor Q16 are all electrically connected to the logic control circuit 100.

In some embodiments, referring to FIG. 4, a leakage path includes a first leakage path and a second leakage path, the first leakage path includes the first switching transistor Q1, the third switching transistor Q3, the fifth switching transistor Q5, and the eleventh switching transistor Q11; and the second leakage path includes the sixth switching transistor Q6, the twelfth switching transistor Q12, the fourteenth switching transistor Q14, and the sixteenth switching transistor Q16.

Referring to FIG. 4, the switching transistors involved in the leakage path from the output voltage terminal OUT to the input voltage terminal IN of the switched-capacitor voltage converter include the first switching transistor Q1, the third switching transistor Q3, the fifth switching transistor Q5, the eleventh switching transistor Q11, the sixth switching transistor Q6, the twelfth switching transistor Q12, the fourteenth switching transistor Q14, and the sixteenth switching transistor Q16. The switching transistors may be organized into a first leakage path and a second leakage path. Leakage from the output voltage terminal OUT to the input voltage terminal IN of the switched-capacitor voltage converter may occur via the first leakage path or via the second leakage path.

In FIG. 4, the switched-capacitor voltage converter circuit 400 has two output terminals, namely the output voltage terminal OUT and the middle voltage terminal VO1, for outputting the output voltage Vout and the middle output voltage Vmid respectively. Using the middle voltage terminal VO1 as a middle node, the first leakage path may be divided into a first leakage branch and a second leakage branch, and the second leakage path may be divided into a third leakage branch and a fourth leakage branch. For example, referring to FIG. 4, the first leakage branch includes the first switching transistor Q1 and the third switching transistor Q3; the second leakage branch includes the fifth switching transistor Q5 and the eleventh switching transistor Q11; the third leakage branch includes the fourteenth switching transistor Q14 and the sixteenth switching transistor Q16; and the fourth leakage branch includes the sixth switching transistor Q6 and the twelfth switching transistor Q12.

Referring to the topology of the switched-capacitor voltage converter with reverse leakage prevention in FIG. 4, to effectively prevent reverse leakage, all leakage paths from the output voltage terminal OUT to the input voltage terminal IN need to be cut off. This means both the first and second leakage paths need to be cut off. Therefore, at least two switching transistors need to be selected: at least one switching transistor from the first leakage path (referred to as the first target switching transistor) and at least one switching transistor from the second leakage path (referred to as the second target switching transistor). It is then necessary to disconnect the original electrical connections of the body diodes and control terminals of the selected first and second

target switching transistors and pull them down to ground to completely cut off both the first and second leakage paths and prevent reverse leakage from occurring.

Therefore, during selecting the first and second target switching transistors, the first target switching transistor may be at least one switching transistor in the first leakage branch, and the second target switching transistor may be at least one switching transistor in the third leakage branch or the fourth leakage branch; or the first target switching transistor may be at least one switching transistor in the second leakage branch, and the second target switching transistor may be at least one switching transistor in the third leakage branch or the fourth leakage branch.

The following lists 8 possible combinations for the selection of the first and second target switching transistors.

Combination 1: The first target switching transistor and the second target switching transistor are the first switching transistor Q1 and the sixteenth switching transistor Q16 respectively.

Combination 2: The first target switching transistor and the second target switching transistor are the first switching transistor Q1 and the fourteenth switching transistor Q14 respectively.

Combination 3: The first target switching transistor and the second target switching transistor are the third switching transistor Q3 and the sixteenth switching transistor Q16 respectively.

Combination 4: The first target switching transistor and the second target switching transistor are the third switching transistor Q3 and the fourteenth switching transistor Q14 respectively.

Combination 5: The first target switching transistor and the second target switching transistor are the fifth switching transistor Q5 and the twelfth switching transistor Q12 respectively.

Combination 6: The first target switching transistor and the second target switching transistor are the fifth switching transistor Q5 and the sixth switching transistor Q6 respectively.

Combination 7: The first target switching transistor and the second target switching transistor are the eleventh switching transistor Q11 and the twelfth switching transistor Q12respectively.

Combination 8: The first target switching transistor and the second target switching transistor are the eleventh switching transistor Q11 and the sixth switching transistor Q6 respectively.

To clearly introduce how the logic control circuit 100 controls the working principle of each combination, FIG. 4 only takes Combination 8 (i.e., the first target switching transistor is the eleventh switching transistor Q11 and the second target switching transistor is the sixth switching transistor Q6) as an example to describe the electrical connection relationship and control process among the logic control circuit 100, the first switching circuit 200, the second switching circuit 300, and the selected switching transistors of Combination 8. The electrical connections for the other combinations are not described, but it is understood that their connection relationships are the same as those of Combination 8.

The first switching circuit 200 includes two series-connected switches. The terminal where the two switches are connected to each other serves as the common terminal of the first switching circuit 200. The other terminals of the two switches serve as the first terminal and the second terminal of the first switching circuit 200 respectively. Similarly, the second switching circuit 300 includes two series-connected switches. The terminal where the two switches are connected to each other serves as the common terminal of the second switching circuit 300. The other terminals of the two switches serve as the first terminal and the second terminal of the second switching circuit 300 respectively.

A common terminal of the first switching circuit 200 is electrically connected to the anode of the body diode of the sixth switching transistor Q6; a first terminal of the first switching circuit 200 is connected to ground; and a second terminal of the first switching circuit 200 is electrically connected to the source of the sixth switching transistor Q6. A common terminal of the second switching circuit 300 is electrically connected to the control terminal of the sixth switching transistor Q6; a first terminal of the second switching circuit 300 is connected to ground; and a second terminal of the second switching circuit 300 is electrically connected to the drive voltage terminal DRV provided by the logic control circuit 100.

A common terminal of the first switching circuit 200 is electrically connected to the anode of the body diode of the eleventh switching transistor Q11; a first terminal of the first switching circuit 200 is connected to ground; and a second terminal of the first switching circuit 200 is electrically connected to the source of the eleventh switching transistor Q11. A common terminal of the second switching circuit 300 is electrically connected to the control terminal of the eleventh switching transistor Q11; a first terminal of the second switching circuit 300 is connected to ground; and a second terminal of the second switching circuit 300 is electrically connected to the drive voltage terminal DRV provided by the logic control circuit 100.

In some embodiments, the first switching circuit 200 connected to the sixth switching transistor Q6 and the first switching circuit 200 connected to the eleventh switching transistor Q11 may be the same one, or may be two separate first switching circuits 200, as illustrated in FIG. 4.

In some embodiments, the second switching circuit 300 connected to the sixth switching transistor Q6 and the second switching circuit 300 connected to the eleventh switching transistor Q11 may be the same one, or may be two separate second switching circuits 300, as illustrated in FIG. 4.

In a case where the switched-capacitor voltage converter is in a non-operating state, and the input voltage Vin applied to the input voltage terminal IN is lower than the output voltage Vout output by the output voltage terminal OUT, and the absolute value of the difference between the input voltage Vin and the output voltage Vout is greater than a predetermined threshold, the logic control circuit 100 controls the switch connected to ground in the first switching circuit 200 to be turned on, causing the anodes of the body diodes of the sixth switching transistor Q6 and the eleventh switching transistor Q11 to be both electrically connected to ground; and controls the switch connected to ground in the second switching circuit 300 to be turned on, causing the control terminals of the sixth switching transistor Q6 and the eleventh switching transistor Q11 to be both electrically connected to ground. By cutting off the leakage paths through both the body diodes and the channels of the sixth switching transistor Q6 and the eleventh switching transistor Q11, all leakage paths from the output voltage terminal OUT to the input voltage terminal IN are cut off, such that reverse leakage of the switched-capacitor voltage converter is prevented. In the present disclosure, since no additional power transistors need to be introduced, the chip area is reduced, the cost is lowered, and the charging efficiency is improved.

The drive voltage terminal DRV is configured to supply a voltage to the control terminals of the sixth switching transistor Q6 and the eleventh switching transistor Q11. In practical applications, the voltage range of the drive voltage terminal DRV is typically set to be from Vout to Vout+5 V. The logic control circuit 100 controls the voltage of the drive voltage terminal DRV to switch between Vout and Vout+5 V to control the on or off state of the sixth switching transistor Q6 and the eleventh switching transistor Q11. For example, in a case where the voltage of the drive voltage terminal DRV is greater than Vout+Vth, the sixth switching transistor Q6 and the eleventh switching transistor Q11 may be turned on, wherein Vth denotes the switching threshold voltage between the gate and source of the sixth switching transistor Q6 and the eleventh switching transistor Q11. Typically, Vth is less than 5V. For example, in a case where the voltage of the drive voltage terminal DRV is Vout, the sixth switching transistor Q6 and the eleventh switching transistor Q11 are turned on because the source voltage is Vout. In a case where the voltage of the drive voltage terminal DRV is Vout+Vth, the sixth switching transistor Q6 and the eleventh switching transistor Q11 are turned on because the source voltage is Vout.

In some embodiments, referring to FIG. 4, in a case where the switched-capacitor voltage converter is in an operating state, the logic control circuit 100 is configured to control the first switching circuit 200 to cause the anodes of the body diodes of the sixth switching transistor Q6 and the eleventh switching transistor Q11 to be both electrically connected to their respective first terminals via the first switching circuit 200; and control the second switching circuit 300 to cause the control terminals of the sixth switching transistor Q6 and the eleventh switching transistor Q11 to be both electrically connected to the drive voltage terminal DRV via the second switching circuit 300, wherein the drive voltage terminal DRV is electrically connected to the logic control circuit 100.

In some embodiments, the predetermined threshold is a minimum value of: four times a forward conduction threshold of the body diode and a sum of conduction thresholds of the four switching transistors in the first leakage path or the second leakage path.

Referring to FIG. 4, the leakage path from the output voltage terminal OUT to the input voltage terminal IN of the switched-capacitor voltage converter includes two leakage paths, and each leakage path includes four switching transistors. Reverse leakage from the output voltage terminal OUT to the input voltage terminal IN may occur via the body diodes of the four switching transistors, or may occur via the channels of the four switching transistors. For example, in a case where the absolute value of the difference between the input voltage Vin and the output voltage Vout is greater than four times the forward conduction threshold of the body diode, leakage may occur via the body diodes of the four switching transistors. In a case where the absolute value of the difference between the input voltage Vin and the output voltage Vout is greater than the sum of the switching threshold voltages of the four switching transistors, leakage may occur via the channels of the four switching transistors. The occurrence of reverse leakage depends on the minimum value of four times the forward conduction threshold of the body diode and the sum of the conduction thresholds of the four switching transistors in the first leakage path or the second leakage path. That is, in a case where the predetermined threshold reaches the minimum value, reverse leakage from the output voltage terminal OUT to the input voltage terminal IN may occur. In this case, the logic control circuit needs to control the target switching transistors to cut off the leakage paths through both the body diodes and the channels of the sixth switching transistor Q6 and the eleventh switching transistor Q11, thereby completely cutting off all leakage paths from the output voltage terminal OUT to the input voltage terminal IN and preventing reverse leakage of the switched-capacitor voltage converter.

Referring to FIG. 4 and taking Combination 8 as an example, in a case where the switched-capacitor voltage converter is in a non-operating state, the input voltage Vin applied to the input voltage terminal IN is lower than the output voltage Vout from the output voltage terminal OUT, and the difference therebetween reaches the minimum value of four times the forward conduction threshold of the body diode and the sum of the conduction thresholds of the four switching transistors in the first leakage path or the second leakage path (i.e., in a case where the absolute value of the difference between the input voltage Vin and the output voltage Vout is greater than the predetermined threshold): the logic control circuit 100 controls the anodes of the body diodes of the eleventh switching transistor Q11 and the sixth switching transistor Q6 to be disconnected from the output voltage terminal OUT and to be electrically connected to ground, thereby cutting off the leakage path through the body diodes of the eleventh switching transistor Q11 and the sixth switching transistor Q6; and controls the gates of the eleventh switching transistor Q11 and the sixth switching transistor Q6 to be disconnected from the drive voltage terminal and to be electrically connected to ground, thereby cutting off the reverse leakage path through the channels of the eleventh switching transistor Q11 and the sixth switching transistor Q6. By cutting off the leakage paths through both the body diodes and the channels of the eleventh switching transistor Q11 and the sixth switching transistor Q6, all leakage paths from the output voltage terminal OUT to the input voltage terminal IN are cut off, such that reverse leakage of the switched-capacitor voltage converter is prevented. In the present disclosure, since no additional power transistors need to be introduced, the chip area is reduced, the cost is lowered, and the charging efficiency is improved.

In some embodiments, the first switching transistor Q1, the second switching transistor Q2, the third switching transistor Q3, the fourth switching transistor Q4, the fifth switching transistor Q5, the sixth switching transistor Q6, the seventh switching transistor Q7, the eighth switching transistor Q8, the ninth switching transistor Q9, the tenth switching transistor Q10, the eleventh switching transistor Q11, the twelfth switching transistor Q12, the thirteenth switching transistor Q13, the fourteenth switching transistor Q14, the fifteenth switching transistor Q15, and the sixteenth switching transistor Q16 are all N-type switching transistors, for example, N-type field-effect transistors (FETs). Herein, the control terminal of each of these switching transistors refers to the gate of the field-effect transistor; the first terminal of each of these switching transistors refers to the source of the field-effect transistor; and correspondingly, the second terminal of each of these switching transistors refers to the drain of the field-effect transistor.

Some embodiments of the present disclosure further provide a chip. The chip includes the above-described switched-capacitor voltage converter.

Some embodiments of the present disclosure further provide an electronic device. The electronic device includes the above-described chip.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

1. A switched-capacitor voltage converter with reverse leakage prevention, comprising: a logic control circuit, a first switching circuit, a second switching circuit, and a switched-capacitor voltage converter circuit, wherein the switched-capacitor voltage converter circuit comprises a first leakage path and a second leakage path, and the switched-capacitor voltage converter circuit has an input voltage terminal and an output voltage terminal; wherein
the logic control circuit is electrically connected to the first switching circuit and the second switching circuit, the first switching circuit is electrically connected to a first target switching transistor in the first leakage path, and the second switching circuit is electrically connected to a second target switching transistor in the second leakage path; and
the logic control circuit is configured to, in a case where the switched-capacitor voltage converter is in a non-operating state, an input voltage applied to the input voltage terminal is lower than an output voltage output by the output voltage terminal, and an absolute value of a difference between the input voltage and the output voltage is greater than a predetermined threshold, control the first switching circuit to cause anodes of body diodes of the first target switching transistor and the second target switching transistor to be both electrically connected to ground via the first switching circuit; and control the second switching circuit to cause control terminals of the first target switching transistor and the second target switching transistor to be both electrically connected to ground via the second switching circuit.

2. The switched-capacitor voltage converter according to claim 1, wherein the switched-capacitor voltage converter circuit further has a middle voltage terminal configured to output a middle output voltage, wherein the middle voltage terminal is configured to divide the first leakage path into a first leakage branch from the middle voltage terminal to the input voltage terminal and a second leakage branch from the output voltage terminal to the middle voltage terminal, and divide the second leakage path into a third leakage branch from the middle voltage terminal to the input voltage terminal and a fourth leakage branch from the output voltage terminal to the middle voltage terminal;
wherein each of the first leakage branch, the second leakage branch, the third leakage branch, and the fourth leakage branch comprises two switching transistors; the first target switching transistor is at least one switching transistor in the first leakage branch, and the second target switching transistor is at least one switching transistor in the third leakage branch or the fourth leakage branch; or the first target switching transistor is at least one switching transistor in the second leakage branch, and the second target switching transistor is at least one switching transistor in the third leakage branch or the fourth leakage branch.

3. The switched-capacitor voltage converter according to claim 1, wherein,
a common terminal of the first switching circuit is electrically connected to the anodes of the body diodes of the first target switching transistor and the second target switching transistor, a first terminal of the first switching circuit is connected to ground, and a second terminal of the first switching circuit is electrically connected to sources of the first target switching transistor and the second target switching transistor; and
a common terminal of the second switching circuit is electrically connected to the control terminals of the first target switching transistor and the second target switching transistor, a first terminal of the second switching circuit is connected to ground, and a second terminal of the second switching circuit is electrically connected to a drive voltage terminal of the logic control circuit.

4. The switched-capacitor voltage converter according to claim 1, wherein, the logic control circuit is configured to, in a case where the switched-capacitor voltage converter is in an operating state, control the first switching circuit to cause the anodes of the body diodes of the first target switching transistor and the second target switching transistor to be both electrically connected to their respective sources via the first switching circuit; and control the second switching circuit to cause the control terminals of the first target switching transistor and the second target switching transistor to be both electrically connected to a drive voltage terminal of the logic control circuit via the second switching circuit.

5. The switched-capacitor voltage converter according to claim 2, wherein the switched-capacitor voltage converter circuit further comprises a first switching transistor, a second switching transistor, a third switching transistor, a fourth switching transistor, a fifth switching transistor, a sixth switching transistor, a seventh switching transistor, an eighth switching transistor, a ninth switching transistor, a tenth switching transistor, an eleventh switching transistor, a twelfth switching transistor, a thirteenth switching transistor, a fourteenth switching transistor, a fifteenth switching transistor, a sixteenth switching transistor, a first capacitor, a second capacitor, a third capacitor, a fourth capacitor, a fifth capacitor, and a sixth capacitor;
wherein
a source of the first switching transistor is electrically connected to a first terminal of the first capacitor and a drain of the third switching transistor, and a drain of the first switching transistor is electrically connected to the input voltage terminal;
a source of the second switching transistor is connected to ground, and a drain of the second switching transistor is electrically connected to a second terminal of the first capacitor and a source of the fourth switching transistor;
a source of the third switching transistor is electrically connected to a drain of the fifth switching transistor and the middle voltage terminal, and the middle voltage terminal is electrically connected to a first terminal of the fifth capacitor, and a second terminal of the fifth capacitor is connected to ground;
a drain of the fourth switching transistor is electrically connected to a source of the twelfth switching transistor, a drain of the sixth switching transistor, and a first terminal of the second capacitor;
a source of the fifth switching transistor is electrically connected to a drain of the thirteenth switching transistor, a drain of the eleventh switching transistor, and a first terminal of the fourth capacitor;
a source of the sixth switching transistor is electrically connected to a drain of the seventh switching transistor and the output voltage terminal, and the output voltage terminal is electrically connected to a first terminal of the sixth capacitor, and a second terminal of the sixth capacitor is connected to ground;
a source of the seventh switching transistor is electrically connected to a second terminal of the second capacitor and a drain of the eighth switching transistor;
a source of the eighth switching transistor is connected to ground;
a source of the sixteenth switching transistor is electrically connected to a drain of the fourteenth switching transistor and a first terminal of the third capacitor, and a drain of the sixteenth switching transistor is electrically connected to the input voltage terminal;
a source of the fifteenth switching transistor is connected to ground, and a drain of the fifteenth switching transistor is electrically connected to a source of the thirteenth switching transistor and a second terminal of the third capacitor;
a source of the fourteenth switching transistor is electrically connected to a drain of the twelfth switching transistor and the middle voltage terminal;
a source of the eleventh switching transistor is electrically connected to a drain of the tenth switching transistor and the output voltage terminal;
a source of the tenth switching transistor is electrically connected to a drain of the ninth switching transistor and a second terminal of the fourth capacitor;
a source of the ninth switching transistor is connected to ground; and
control terminals of the first switching transistor, the second switching transistor, the third switching transistor, the fourth switching transistor, the fifth switching transistor, the sixth switching transistor, the seventh switching transistor, the eighth switching transistor, the ninth switching transistor, the tenth switching transistor, the eleventh switching transistor, the twelfth switching transistor, the thirteenth switching transistor, the fourteenth switching transistor, the fifteenth switching transistor, and the sixteenth switching transistor are all electrically connected to the logic control circuit.

6. The switched-capacitor voltage converter according to claim 5, wherein the first leakage path comprises the first switching transistor, the third switching transistor, the fifth switching transistor, and the eleventh switching transistor; and the second leakage path comprises the sixth switching transistor, the twelfth switching transistor, the fourteenth switching transistor, and the sixteenth switching transistor.

7. The switched-capacitor voltage converter according to claim 6, wherein the first leakage branch comprises the first switching transistor and the third switching transistor, the second leakage branch comprises the fifth switching transistor and the eleventh switching transistor, the third leakage branch comprises the fourteenth switching transistor and the sixteenth switching transistor, and the fourth leakage branch comprises the sixth switching transistor and the twelfth switching transistor.

8. The switched-capacitor voltage converter according to claim 1, wherein the predetermined threshold is a minimum value of: four times a forward conduction threshold of the body diode and a sum of conduction thresholds of four switching transistors in the first leakage path or the second leakage path.

9. The switched-capacitor voltage converter according to claim 5, wherein the first switching transistor, the second switching transistor, the third switching transistor, the fourth switching transistor, the fifth switching transistor, the sixth switching transistor, the seventh switching transistor, the eighth switching transistor, the ninth switching transistor, the tenth switching transistor, the eleventh switching transistor, the twelfth switching transistor, the thirteenth switching transistor, the fourteenth switching transistor, the fifteenth switching transistor, and the sixteenth switching transistor are all N-type switching transistors.

10. A chip, comprising:
a switched-capacitor voltage converter, comprising: a logic control circuit, a first switching circuit, a second switching circuit, and a switched-capacitor voltage converter circuit;
wherein the switched-capacitor voltage converter circuit comprises a first leakage path and a second leakage path, and the switched-capacitor voltage converter circuit has an input voltage terminal and an output voltage terminal; wherein
the logic control circuit is electrically connected to the first switching circuit and the second switching circuit, the first switching circuit is electrically connected to a first target switching transistor in the first leakage path, and the second switching circuit is electrically connected to a second target switching transistor in the second leakage path; and
the logic control circuit is configured to, in a case where the switched-capacitor voltage converter is in a non-operating state, an input voltage applied to the input voltage terminal is lower than an output voltage output by the output voltage terminal, and an absolute value of a difference between the input voltage and the output voltage is greater than a predetermined threshold, control the first switching circuit to cause anodes of body diodes of the first target switching transistor and the second target switching transistor to be both electrically connected to ground via the first switching circuit; and control the second switching circuit to cause control terminals of the first target switching transistor and the second target switching transistor to be both electrically connected to ground via the second switching circuit.

11. The chip according to claim 10, wherein the switched-capacitor voltage converter circuit further has a middle voltage terminal configured to output a middle output voltage, wherein the middle voltage terminal is configured to divide the first leakage path into a first leakage branch from the middle voltage terminal to the input voltage terminal and a second leakage branch from the output voltage terminal to the middle voltage terminal, and divide the second leakage path into a third leakage branch from the middle voltage terminal to the input voltage terminal and a fourth leakage branch from the output voltage terminal to the middle voltage terminal;
wherein each of the first leakage branch, the second leakage branch, the third leakage branch, and the fourth leakage branch comprises two switching transistors; the first target switching transistor is at least one switching transistor in the first leakage branch, and the second target switching transistor is at least one switching transistor in the third leakage branch or the fourth leakage branch; or the first target switching transistor is at least one switching transistor in the second leakage branch, and the second target switching transistor is at least one switching transistor in the third leakage branch or the fourth leakage branch.

12. The chip according to claim 10, wherein,
a common terminal of the first switching circuit is electrically connected to the anodes of the body diodes of the first target switching transistor and the second target switching transistor, a first terminal of the first switching circuit is connected to ground, and a second terminal of the first switching circuit is electrically connected to sources of the first target switching transistor and the second target switching transistor; and
a common terminal of the second switching circuit is electrically connected to the control terminals of the first target switching transistor and the second target switching transistor, a first terminal of the second switching circuit is connected to ground, and a second terminal of the second switching circuit is electrically connected to a drive voltage terminal of the logic control circuit.

13. The chip according to claim 10, wherein, the logic control circuit is configured to, in a case where the switched-capacitor voltage converter is in an operating state, control the first switching circuit to cause the anodes of the body diodes of the first target switching transistor and the second target switching transistor to be both electrically connected to their respective sources via the first switching circuit; and control the second switching circuit to cause the control terminals of the first target switching transistor and the second target switching transistor to be both electrically connected to a drive voltage terminal of the logic control circuit via the second switching circuit.

14. The chip according to claim 11, wherein the switched-capacitor voltage converter circuit comprises a first switching transistor, a second switching transistor, a third switching transistor, a fourth switching transistor, a fifth switching transistor, a sixth switching transistor, a seventh switching transistor, an eighth switching transistor, a ninth switching transistor, a tenth switching transistor, an eleventh switching transistor, a twelfth switching transistor, a thirteenth switching transistor, a fourteenth switching transistor, a fifteenth switching transistor, a sixteenth switching transistor, a first capacitor, a second capacitor, a third capacitor, a fourth capacitor, a fifth capacitor, and a sixth capacitor;
wherein
a source of the first switching transistor is electrically connected to a first terminal of the first capacitor and a drain of the third switching transistor, and a drain of the first switching transistor is electrically connected to the input voltage terminal;
a source of the second switching transistor is connected to ground, and a drain of the second switching transistor is electrically connected to a second terminal of the first capacitor and a source of the fourth switching transistor;
a source of the third switching transistor is electrically connected to a drain of the fifth switching transistor and the middle voltage terminal, and the middle voltage terminal is electrically connected to a first terminal of the fifth capacitor, and a second terminal of the fifth capacitor is connected to ground;
a drain of the fourth switching transistor is electrically connected to a source of the twelfth switching transistor, a drain of the sixth switching transistor, and a first terminal of the second capacitor;
a source of the fifth switching transistor is electrically connected to a drain of the thirteenth switching transistor, a drain of the eleventh switching transistor, and a first terminal of the fourth capacitor;
a source of the sixth switching transistor is electrically connected to a drain of the seventh switching transistor and the output voltage terminal, and the output voltage terminal is electrically connected to a first terminal of the sixth capacitor, and a second terminal of the sixth capacitor is connected to ground;
a source of the seventh switching transistor is electrically connected to a second terminal of the second capacitor and a drain of the eighth switching transistor;
a source of the eighth switching transistor is connected to ground;
a source of the sixteenth switching transistor is electrically connected to a drain of the fourteenth switching transistor and a first terminal of the third capacitor, and a drain of the sixteenth switching transistor is electrically connected to the input voltage terminal;
a source of the fifteenth switching transistor is connected to ground, and a drain of the fifteenth switching transistor is electrically connected to a source of the thirteenth switching transistor and a second terminal of the third capacitor;
a source of the fourteenth switching transistor is electrically connected to a drain of the twelfth switching transistor and the middle voltage terminal;
a source of the eleventh switching transistor is electrically connected to a drain of the tenth switching transistor and the output voltage terminal;
a source of the tenth switching transistor is electrically connected to a drain of the ninth switching transistor and a second terminal of the fourth capacitor;
a source of the ninth switching transistor is connected to ground; and
control terminals of the first switching transistor, the second switching transistor, the third switching transistor, the fourth switching transistor, the fifth switching transistor, the sixth switching transistor, the seventh switching transistor, the eighth switching transistor, the ninth switching transistor, the tenth switching transistor, the eleventh switching transistor, the twelfth switching transistor, the thirteenth switching transistor, the fourteenth switching transistor, the fifteenth switching transistor, and the sixteenth switching transistor are all electrically connected to the logic control circuit.

15. The chip according to claim 14, wherein the first leakage branch comprises the first switching transistor and the third switching transistor, the second leakage branch comprises the fifth switching transistor and the eleventh switching transistor, the third leakage branch comprises the fourteenth switching transistor and the sixteenth switching transistor, and the fourth leakage branch comprises the sixth switching transistor and the twelfth switching transistor.

16. An electronic device, comprising:
a switched-capacitor voltage converter, comprising: a logic control circuit, a first switching circuit, a second switching circuit, and a switched-capacitor voltage converter circuit;
wherein the switched-capacitor voltage converter circuit comprises a first leakage path and a second leakage path, and the switched-capacitor voltage converter circuit has an input voltage terminal and an output voltage terminal; wherein
the logic control circuit is electrically connected to the first switching circuit and the second switching circuit, the first switching circuit is electrically connected to a first target switching transistor in the first leakage path, and the second switching circuit is electrically connected to a second target switching transistor in the second leakage path; and
the logic control circuit is configured to, in a case where the switched-capacitor voltage converter is in a non-operating state, an input voltage applied to the input voltage terminal is lower than an output voltage output by the output voltage terminal, and an absolute value of a difference between the input voltage and the output voltage is greater than a predetermined threshold, control the first switching circuit to cause anodes of body diodes of the first target switching transistor and the second target switching transistor to be both electrically connected to ground via the first switching circuit; and control the second switching circuit to cause control terminals of the first target switching transistor and the second target switching transistor to be both electrically connected to ground via the second switching circuit.

17. The electronic device according to claim 16, wherein the switched-capacitor voltage converter circuit further has a middle voltage terminal configured to output a middle output voltage, wherein the middle voltage terminal is configured to divide the first leakage path into a first leakage branch from the middle voltage terminal to the input voltage terminal and a second leakage branch from the output voltage terminal to the middle voltage terminal, and divide the second leakage path into a third leakage branch from the middle voltage terminal to the input voltage terminal and a fourth leakage branch from the output voltage terminal to the middle voltage terminal;
wherein each of the first leakage branch, the second leakage branch, the third leakage branch, and the fourth leakage branch comprises two switching transistors; the first target switching transistor is at least one switching transistor in the first leakage branch, and the second target switching transistor is at least one switching transistor in the third leakage branch or the fourth leakage branch; or the first target switching transistor is at least one switching transistor in the second leakage branch, and the second target switching transistor is at least one switching transistor in the third leakage branch or the fourth leakage branch.

18. The electronic device according to claim 16, wherein,
a common terminal of the first switching circuit is electrically connected to the anodes of the body diodes of the first target switching transistor and the second target switching transistor, a first terminal of the first switching circuit is connected to ground, and a second terminal of the first switching circuit is electrically connected to sources of the first target switching transistor and the second target switching transistor; and
a common terminal of the second switching circuit is electrically connected to the control terminals of the first target switching transistor and the second target switching transistor, a first terminal of the second switching circuit is connected to ground, and a second terminal of the second switching circuit is electrically connected to a drive voltage terminal of the logic control circuit.

19. The electronic device according to claim 16, wherein, the logic control circuit is configured to, in a case where the switched-capacitor voltage converter is in an operating state, control the first switching circuit to cause the anodes of the body diodes of the first target switching transistor and the second target switching transistor to be both electrically connected to their respective sources via the first switching circuit; and control the second switching circuit to cause the control terminals of the first target switching transistor and the second target switching transistor to be both electrically connected to a drive voltage terminal of the logic control circuit via the second switching circuit.

20. The electronic device according to claim 16, wherein the switched-capacitor voltage converter circuit comprises a first switching transistor, a second switching transistor, a third switching transistor, a fourth switching transistor, a fifth switching transistor, a sixth switching transistor, a seventh switching transistor, an eighth switching transistor, a ninth switching transistor, a tenth switching transistor, an eleventh switching transistor, a twelfth switching transistor, a thirteenth switching transistor, a fourteenth switching transistor, a fifteenth switching transistor, a sixteenth switching transistor, a first capacitor, a second capacitor, a third capacitor, a fourth capacitor, a fifth capacitor, and a sixth capacitor;
wherein
a source of the first switching transistor is electrically connected to a first terminal of the first capacitor and a drain of the third switching transistor, and a drain of the first switching transistor is electrically connected to the input voltage terminal;
a source of the second switching transistor is connected to ground, and a drain of the second switching transistor is electrically connected to a second terminal of the first capacitor and a source of the fourth switching transistor;
a source of the third switching transistor is electrically connected to a drain of the fifth switching transistor and the middle voltage terminal, and the middle voltage terminal is electrically connected to a first terminal of the fifth capacitor, and a second terminal of the fifth capacitor is connected to ground;
a drain of the fourth switching transistor is electrically connected to a source of the twelfth switching transistor, a drain of the sixth switching transistor, and a first terminal of the second capacitor;
a source of the fifth switching transistor is electrically connected to a drain of the thirteenth switching transistor, a drain of the eleventh switching transistor, and a first terminal of the fourth capacitor;
a source of the sixth switching transistor is electrically connected to a drain of the seventh switching transistor and the output voltage terminal, and the output voltage terminal is electrically connected to a first terminal of the sixth capacitor, and a second terminal of the sixth capacitor is connected to ground;
a source of the seventh switching transistor is electrically connected to a second terminal of the second capacitor and a drain of the eighth switching transistor;
a source of the eighth switching transistor is connected to ground;
a source of the sixteenth switching transistor is electrically connected to a drain of the fourteenth switching transistor and a first terminal of the third capacitor, and a drain of the sixteenth switching transistor is electrically connected to the input voltage terminal;
a source of the fifteenth switching transistor is connected to ground, and a drain of the fifteenth switching transistor is electrically connected to a source of the thirteenth switching transistor and a second terminal of the third capacitor;
a source of the fourteenth switching transistor is electrically connected to a drain of the twelfth switching transistor and the middle voltage terminal;
a source of the eleventh switching transistor is electrically connected to a drain of the tenth switching transistor and the output voltage terminal;
a source of the tenth switching transistor is electrically connected to a drain of the ninth switching transistor and a second terminal of the fourth capacitor;
a source of the ninth switching transistor is connected to ground; and
control terminals of the first switching transistor, the second switching transistor, the third switching transistor, the fourth switching transistor, the fifth switching transistor, the sixth switching transistor, the seventh switching transistor, the eighth switching transistor, the ninth switching transistor, the tenth switching transistor, the eleventh switching transistor, the twelfth switching transistor, the thirteenth switching transistor, the fourteenth switching transistor, the fifteenth switching transistor, and the sixteenth switching transistor are all electrically connected to the logic control circuit.
